(19) United States
(12) Patent Application Publication
(10) Pub. No.: US 2025/0219343 A1
(43) Pub. Date: Jul. 3, 2025

(54) ELECTRICAL CONNECTOR STRUCTURE AND TERMINAL MANUFACTURING METHOD THEREOF

(71) Applicant: Li Hong TECHNOLOGY SOLUTIONS CO., LTD., TAOYUAN CITY (TW)

(72) Inventor: Cheng-yang LI, TAOYUAN CITY (TW)

(21) Appl. No.: 18/989,092

(22) Filed: Dec. 20, 2024

(30) Foreign Application Priority Data
Dec. 29, 2023 (TW) 112151555

(51) Int. Cl. H01R 43/16; H01R 12/70; H01R 12/71

(52) U.S. Cl. CPC H01R 43/16; H01R 12/7005; H01R 12/716

(57) ABSTRACT

An electrical connector structure and terminal manufacturing method thereof are provided. The electrical connector structure is configured to connect an optoelectronic transceiver module to a motherboard. The electrical connector structure includes an interposer module and a fixed structure. Terminal modules of the interposer module are arranged side by side. The terminal manufacturing method includes providing a material strip; placing the material strip in a stamping machine; performing a stamping process on the material strip with the stamping machine, and forming at least one terminal and at least one material strip fixing portion on the material strip, wherein at least one terminal is connected to at least one material strip fixing portion on the material strip; and separating the at least one terminal from the material strip fixing portion.

### CROSS REFERENCE TO RELATED APPLICATIONS

The present invention claims priority of the Taiwan Patent Application No. 112151555, filed on Dec. 29, 2023 with the Taiwan Intellectual Property Office, which is incorporated by reference in the present invention in its entirety.

### FIELD OF INVENTION

The present application relates to the field of connectors, and specifically refers to an electrical connector structure and a terminal manufacturing method for connecting an optoelectronic transceiver module to a motherboard.

### BACKGROUND OF INVENTION

Replacing electrons with photons for computation in integrated circuits and using light as the medium for data transmission to achieve high-capacity and high-speed signal transmission is an inevitable trend for the future. Optoelectronic integrated circuits have been developed, utilizing co-packaging technology to form optoelectronic transceiver components. These are applicable to high-performance data exchange, long-distance interconnects, 5G infrastructure, and computing devices. However, current co-packaged optical transceiver components must be connected to the motherboard via cables and connectors, resulting in excessively long signal transmission paths that hinder transmission efficiency. This prevents the full utilization of the high transmission bandwidth density and high-speed characteristics of co-packaged optical transceiver components, while also making maintenance and replacement challenging. In view of this, how to improve the connection between the current co-packaged optical transceiver components and the motherboard is an urgent issue that needs to be solved.

In addition, in the conventional technology, as shown in FIG. 17, the pins of the connector are usually made by etching. Generally, the process of etching to produce pins involves multiple steps, including metal etching plates, degreasing, water rinsing, etching, and drying. Moreover, if pins are manufactured using the etching method, it becomes difficult to adjust the number of pins, leading to various inconveniences.

Furthermore, in the conventional manufacturing method, the printed circuit board and the pins formed by etching need to be bonded to each other, and finally a stacked structure is formed, which is very energy-consuming. Moreover, in the conventional manufacturing process, due to the need for etching, it is also necessary to consider the adaptability of photomasks, printed circuit boards, etc., which increases the difficulty of designing the manufacturing process. On average, it takes approximately 4 to 6 months to achieve mass production of the product, which is extremely time-consuming and leads to various issues.

### SUMMARY OF INVENTION

Based on the above purpose, the present application provides a terminal manufacturing method, includes the following steps:
providing a material strip;
placing the material strip in a stamping machine;
performing a stamping process on the material strip by the stamping machine, and forming at least one terminal and at least one material strip fixing portion on the material strip, wherein the at least one terminal is connected to the at least one material strip fixing portion; and
separating the at least one terminal from the at least one material strip fixing portion.

Preferably, the terminal manufacturing method of the present application further includes forming a plurality of terminal protection feet by performing the stamping process through the stamping machine.

Preferably, the terminal manufacturing method of the present application further includes cutting the plurality of terminal protection feet by laser.

Preferably, the terminal manufacturing method of the present application further includes forming a plurality of first positioning holes on one side of the material strip, wherein a feeding mechanism sequentially pushes the material strip in one direction through the plurality of first positioning holes.

Preferably, the terminal manufacturing method of the present application further includes cutting the plurality of terminal protection feet by laser.

Preferably, the terminal manufacturing method of the present application further includes forming a plurality of second positioning holes on the other side of the material strip, wherein the feeding mechanism sequentially pushes the material strip in one direction through the plurality of first positioning holes and the plurality of second positioning holes.

Preferably, after the one less terminal formed, the terminal manufacturing method of the present application further includes electroplating the at least one terminal.

Preferably, the terminal manufacturing method of the present application further includes plating nickel on the at least one terminal by electroplating, and then plating silver, gold, or palladium on the at least one terminal by electroplating.

Preferably, the material strip is defined with a plurality of stamping areas, and wherein the terminal manufacturing method further includes forming a plurality of terminals in each of the stamping areas by using a mold of the stamping machine.

Preferably, the terminal manufacturing method further includes laser cutting the connection portions between the plurality of terminals in each of the stamping areas according to a predetermined number.

Preferably, the material strip is defined with a plurality of stamping areas, and wherein the terminal manufacturing method further includes forming each terminal in each stamping area.

Based on the above purpose, the present application further provides electrical connector structure for connecting an optoelectronic transceiver module on a motherboard, wherein the electrical connector structure includes: an interposer module including a plurality of terminal modules, wherein each of the plurality of terminal modules includes a plurality of terminals, and wherein each of the plurality of terminal modules are arranged side by side; and a fixed structure including a pair of fixed walls, a plurality of first limiters, and a second limiter, wherein the pair of fixed walls are arranged on the motherboard and are spaced apart from each other to form an accommodation space, wherein the plurality of first limiters are respectively disposed on the pair of fixed walls and protrude toward the accommodation space, wherein the second limiter is disposed above the plurality of first limiters, wherein the interposer module and the optoelectronic transceiver module can be stacked in sequence and detachably arranged in the accommodation space, and wherein the plurality of first limiters limit the interposer module on the motherboard, and wherein the second limiters limit the optoelectronic transceiver module on the interposer module, and wherein the optoelectronic transceiver module is electrically connected to the motherboard through a plurality of terminals of the interposer module.

Preferably, the interposer module further includes a first board body and a second board body assembled with each other, and wherein the terminal module is disposed between the board body and the second board body and the terminal module including a terminal base and a plurality of terminals, and wherein each terminal includes a root portion, a first terminal arm and a second terminal arm, and wherein the root portion is fixed to the terminal base, and wherein one terminal of the first terminal arm extends out of the first board body, and wherein one terminal of the second terminal arm extends out of the second board body.

In one embodiment of the terminal manufacturing method provided in the present application, the required number of terminals can be adjusted using laser cutting to produce the terminal module. In another embodiment of the terminal manufacturing method provided in the present application, terminals can be formed independently, allowing subsequent assembly of the terminal module based on the required number of terminals without the need for further laser cutting. In addition, the terminals in the present application are manufactured by performing a stamping process, which offers advantages over the conventional etching method, such as dimensional stability, high precision, fast production, and convenient terminal storage and protection.

In the electrical connector structure of the embodiment of the present application, the interposer module and the optoelectronic transceiver module can be stacked in sequence by crimping and detachably provided in the fixed structure, and the use of the first limiter and the second limiter firmly press the interposer module and the optoelectronic transceiver module respectively, so that the optoelectronic transceiver module can be connected to the electrical connector structure through a simple crimping method. Therefore, the integrated terminals of the interposer module are directly electrically connected to the motherboard, so that the photoelectrically converted electrical signals from the optoelectronic transceiver module can be transmitted to the motherboard, so as to fully utilize the advantages of high-capacity and high-speed transmission provided by the optoelectronic transceiver module, to further shorten the transmission distance between the optical transceiver module and the motherboard, to effectively solve the problem that currently co-packaged optical transceiver components must be connected to the motherboard through cables and connectors, resulting in long transmission paths and difficulty in repair and replacement.

### DESCRIPTION OF FIGURES

FIG. 1 is a schematic diagram of manufacturing terminals by stamping in one embodiment of the present application.

FIG. 2A is a schematic diagram of a terminal manufactured by a first terminal module manufacturing method in the present application.

FIG. 2B is a schematic diagram of a terminal manufactured by the first terminal module manufacturing method in the present application.

FIG. 2C is a schematic flow chart of the first terminal module manufacturing method according to one embodiment of the present application.

FIG. 2D is a schematic flow chart of the second terminal module manufacturing method according to one embodiment of the present application.

FIG. 3A is a schematic diagram of buried injection in the first terminal module manufacturing method according to one embodiment of the present application.

FIG. 3B is a schematic diagram of buried incidence in the second terminal module manufacturing method according to one embodiment of the present application.

FIG. 4 is a schematic three-dimensional combination diagram of an electrical connector structure and a motherboard according to one embodiment of the present application.

FIG. 5 is an exploded schematic diagram of the electrical connector structure of FIG. 4.

FIG. 6 is a three-dimensional exploded schematic diagram of the interposer module according to one embodiment of the present application.

FIG. 7 is a partially enlarged schematic diagram of the terminal module according to one embodiment of the present application.

FIG. 8 is a three-dimensional exploded schematic diagram of the electrical connector structure and an optoelectronic transceiver module according to one embodiment of the present application.

FIG. 9 is a schematic three-dimensional combination diagram of the electrical connector structure and the optoelectronic transceiver module of FIG. 8.

FIG. 10 is a top view of the electrical connector structure, the optoelectronic transceiver module, and the motherboard of FIG. 9.

FIG. 11 is a cross-sectional view of line A-A in FIG. 10.

FIG. 12 is a cross-sectional view of line B-B in FIG. 10.

FIG. 13 is a schematic three-dimensional combination diagram of the electrical connector structure and the optoelectronic transceiver module of FIG. 9 from a downward perspective.

FIGS. 14A to 14F are schematic flow diagrams of the optoelectronic transceiver module being connected to the electrical connector structure of the embodiment of the present application in a crimping manner.

FIG. 15 is a schematic structural diagram of a contact between the terminal and the optoelectronic transceiver module according to one embodiment of the present application.

FIG. 16 is a schematic diagram of the electrical connector structure in use according to one embodiment of the present application.

FIG. 17 is a schematic flow chart of manufacturing terminals by etching in the conventional technology.

### DETAILED DESCRIPTION OF PREFERRED EMBODIMENTS

The following description of the present application is accompanied by the figures that are incorporated and constitute a part of the specification to illustrate the embodiments of the present application. However, the present application is not limited to the embodiments. In addition, the following embodiments may be appropriately integrated to complete another embodiment.

The following description of each embodiment refers to the accompanying figures to illustrate specific embodiments in which the present application can be implemented. Directional terms mentioned in the present application, such as “up”, “down”, “front”, “back”, “left”, “right”, “top”, “bottom”, “horizontal”, “vertical”, etc., only refer to the direction of the attached figure. Therefore, unless otherwise expressly specified and limited, the directional terms are used to explain and understand the present application, but not to limit the present application.

As used herein, unless otherwise noted, the ordinal adjectives “first,” “second,” and “third,” etc., used herein to describe generic objects are merely indicative of different instances of similar objects being referred to, and are not intended to imply that the objects so described must be in a given order in time, space, by arrangement, or by any other means.

In order to make the present application fully understandable, the following description provides detailed steps and structures. It will be understood that the practice of the present application will not be limited to the specific details known to those skilled in the art. In addition, known structures and steps will not be described in detail to avoid unnecessarily limiting the present application. It should be noted that in the description of the present application, the functions or steps mentioned herein may appear in an order different from the order noted in the figures. For example, two figures shown in succession may, in fact, be performed substantially concurrently or sometimes in the reverse order, depending upon the functions or steps involved.

Embodiments of the present application provide an electrical connector structure and a terminal manufacturing method thereof. The electrical connector structure is used to connect an optoelectronic transceiver module on a motherboard. It is further explained that the terminals of the present application are made by stamping method, which has the advantages of high precision, fast speed, low cost, small size and other advantages in manufacturing.

To further explain, in some embodiments, the optoelectronic transceiver module is an optoelectronic integrated circuit (OEIC) that integrates electronic integrated circuits and photonic integrated circuits, and uses co-packaging technology to form an co-packaged optics (CPO) transceiver module. Preferably, the optoelectronic transceiver module may include at least one light detection component and a light source module, and a plurality of active components and passive components, such as but not limited to filters or multiplexing structures, optical power distribution structures, optical fiber input/output structures and optical modulation structure. Since the present application is not characterized by the structure of the optoelectronic transceiver module known to those skilled in the art, its details will not be described in detail here. In some embodiments, the optoelectronic transceiver module connected to the electrical connector structure of the present application has a component structure that complies with the 3.2 Tb/s co-packaged module implementation protocol stipulated by the Optical Internet Forum (OIF).

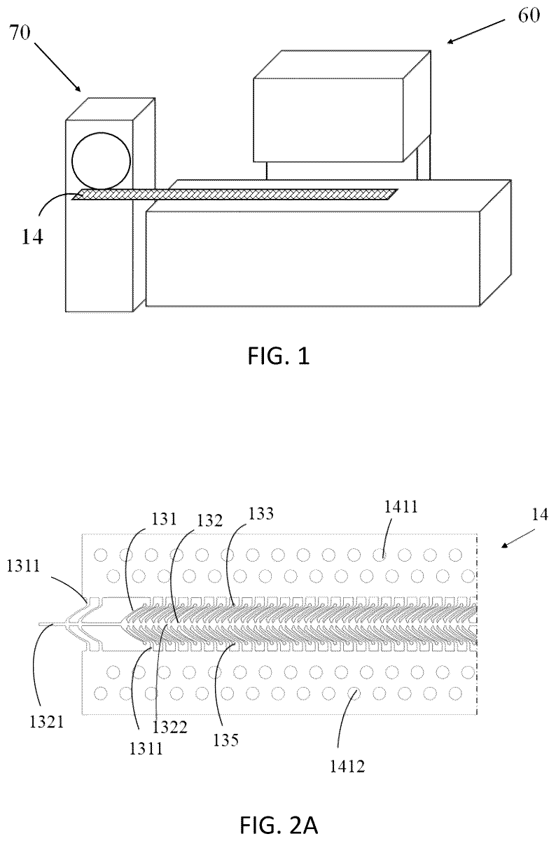

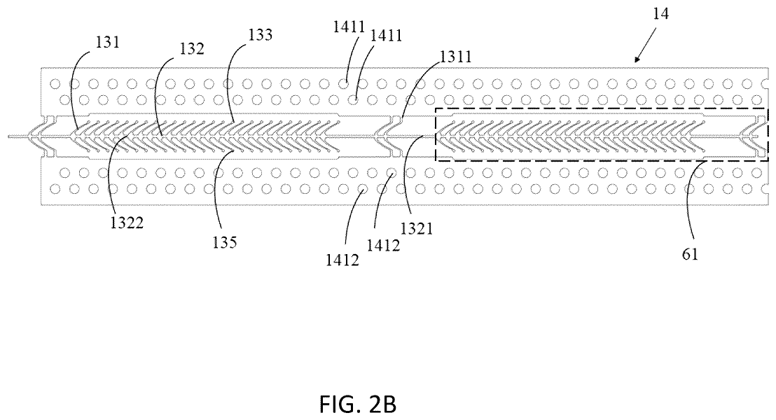

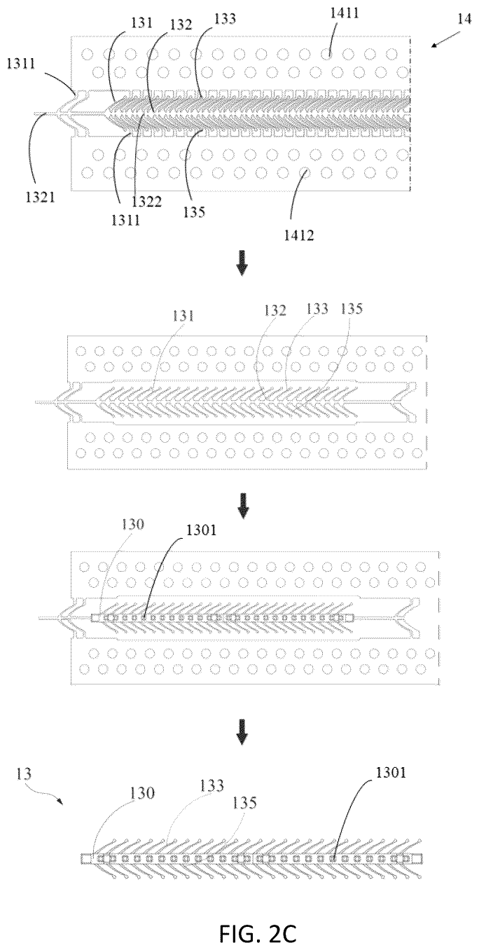

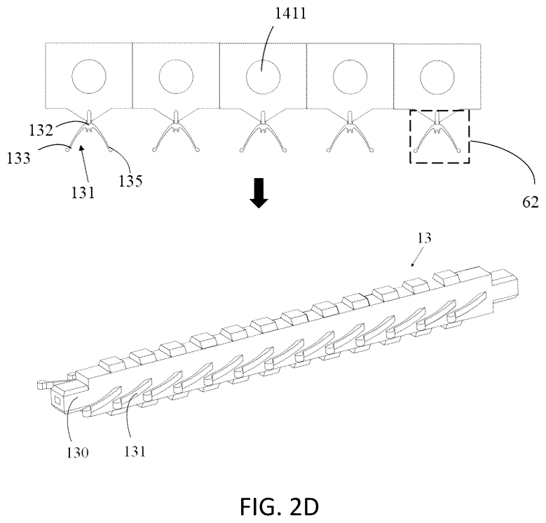

The present application provides a terminal manufacturing method, including the following methods:
As shown in FIG. 1, providing a material strip 14;
Placing the material strip 14 in the stamping machine 60;
As shown in FIG. 1 and FIGS. 2A to 2D, the stamping machine 60 is used to stamp the material strip 14, and at least one terminal 131 and at least one material strip fixing portion 141 are formed on the material strip 14, wherein the at least one terminal 131 is connected to the at least one material strip fixing portion 141; and
Separating the at least one terminal 131 from the at least one material strip fixing portion 141.

To further explain, in the subsequent manufacturing process of the terminal module 13, the terminal base 130 can be formed on the plurality of terminals 131 first, and then the plurality of terminals 131 are separated from the at least one material strip fixing portion 141; or first After the plurality of terminals 131 are separated from at least one material strip fixing portion 141, the terminal base 130 is formed on the plurality of terminals 131.

To further explain, the material strip 14 can be made of metal sheets, and in a preferred embodiment, the material strip 14 can be made of beryllium copper alloy, which has the advantages of light weight and high strength.

In one embodiment, when stamping the material strip 14 by the stamping machine 60, the material strip fixing portion 141 is first formed on the material strip 14 for positioning and feeding when the terminals 131 are subsequently formed. To further explain, in another embodiment, as shown in FIG. 2A, when forming the terminal 131, the stamping machine 60 can also form the terminal protection feet 1311 to increase a strength and avoid damaging the terminal 131 when the material strip 14 is curled. In one embodiment, as shown in FIGS. 2A and 2B, part of the terminal protection feet 1311 can be removed by laser cutting to facilitate subsequent manufacturing processes.

In one embodiment, the present application stamps and forms the terminals 131 in two different ways. It is further explained that the stamping tonnage of the stamping machine 60 can be 50 tons, and the accuracy is less than +/−0.01 mm. In the first terminal manufacturing method, the number of stamping times per minute is about 200 times, and two terminals 131 are formed at one time. In the second terminal manufacturing method, the number of stamping times per minute is about 300, and one terminal 131 is formed at one time. In other embodiments, the stamping machine 60 may have other stamping tonnage, and depending on the manufacturing of the stamping die, a larger number of terminals 131 may be formed at one time, for example, three terminals 131 may be formed at one time, etc.

As shown in FIGS. 2A to 2C, in the first terminal method, the terminals 131 are connected with the first connection portion 1321 and the second connection portion 1322. The material strip 14 defines a plurality of stamping areas 61, and the plurality of terminals 131 are continuously formed in each stamping area 61 by a mold of the stamping machine 60. In this embodiment, a length of the first connection portion 1321 is longer than a length of the second connection portion 1322, and the length of the second connection portion 1322 ranges from 0.5 mm to 0.7 mm, preferably 0.6 mm, to maintain a spacing between the terminals 131.

In the embodiment in which the first connection portion 1321 and the second connection portion 1322 are connected to the terminal 131, since two terminals 131 are formed at one time, in order to feed the material strip 14 into the stamping machine 60 more accurately, therefore, the terminal manufacturing method of the present application may further include forming a plurality of first positioning holes 1411 on one side of the material strip 14 and forming a plurality of second positioning holes 1412 on the other side of the material strip 14 to position two direction of the material strip 14. To further explain, the feeder 70 sequentially pushes the material strip 14 in one direction through the plurality of first positioning holes 1411 and the plurality of second positioning holes 1412 to facilitate the subsequent stamping machine 60 to manufacture the terminals 131.

As shown in FIG. 2D, the second terminal method is to manufacture the terminals 131 independently, and the terminals 131 are not connected to each other by the above-mentioned first connection portion 1321 and the second connection portion 1322. In this embodiment, the material strip 14 is still defined with a plurality of stamping areas 62, and each terminal 131 is formed in each stamping area 62. At this time, only a plurality of first positioning holes 1411 will be formed on one side of the material strip 14, for the feeder 70 to sequentially push the material strip 14 in one direction through the plurality of first positioning holes 1411, so as to facilitate the stamping machine 60 to subsequent manufacture the terminal 131.

The terminal 131 in the embodiment of the present application uses a metal strip to perform a stamping process to form an integrally formed terminal structure. After the outline of the terminal 131 is stamped out, the electroplating process can be further performed. It is further explained that before the electroplating process, since the terminals 131 are formed of a soft metal strip, it can be rolled up and stored, thereby reducing storage space.

It is worth mentioning that, in one embodiment, the terminals 131 manufactured by the first terminal method can remove unnecessary terminals 131 according to a predetermined number, such as any number ranges from 1 to 30. For example, the first connection portion 1321 and/or the second connection portion 1322 between the terminals 131 can be cut by laser to obtain a predetermined number of terminals 131, and these terminals 131 are connected to each other through the second connection portion 1322. For the terminals 131 manufactured by the second terminal method, the above-mentioned step of removing the terminals 131 is not performed because each terminal 131 is formed by independent stamping.

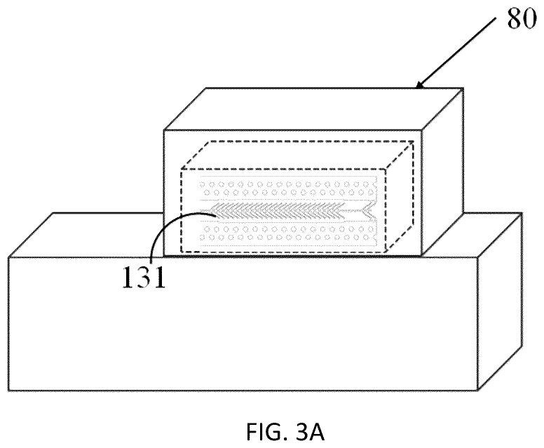

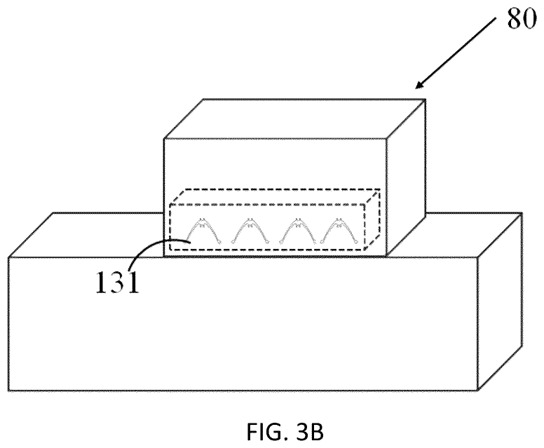

After an outline of the terminal 131 is stamped out by the process, the terminal manufacturing method of the present application further includes electroplating the terminal 131. In one embodiment, the electroplating method includes plating nickel on at least one terminal 131 and then plating silver, gold or palladium on the terminal 131. In one preferred embodiment, the electroplating method further includes a selective plating method or a spray plating method. The selective plating method electroplates where a plating layer is required, and the spray plating method can form a plating layer on the terminal 131 by spraying. After the plating layer is formed, a terminal base 130 can be further manufactured on the terminal 131 to form the terminal module 13 and assembled with other components to form the electrical connector structure 1 of FIG. 3. To further explain, before forming the terminal base, since the terminal 131 is formed of a soft metal strip, it can be rolled up and stored, thereby reducing storage space.

After the plating layer is formed on the terminals 131, in one embodiment, the present application further includes using an embedded injection molding technology to form the terminal base 130 on the rows of terminals 131. To further explain, in one embodiment, the terminal module manufacturing method further includes forming the terminal base 130 on the plurality of terminals 131 by a plastic molding machine 80.

As shown in FIG. 2C and FIG. 3A, for the terminal 131 manufactured by the first terminal manufacturing method, after forming the plating layer on the terminal 131, the material strip 14 and the material strip fixing portion 141 and the terminal 131 thereof are placed in the plastic molding machine 80, wherein the terminal base 130 is formed on the terminal 131 by the plastic molding machine 80, and then it is cut by using a laser.

In one embodiment, a plurality of holes 1301 are formed on the terminal base 130. These holes 1301 are formed on the terminals 131 together with the terminal base 130 and between the plurality of connected terminals 131.

In order to avoid short circuits between the terminals 131, in the present application, the terminal module manufacturing method further includes cutting a plurality of second connection portions 1322 and first connection portions 1321 connected between the plurality of terminals 131 in the same stamping area 61 corresponding to the plurality of holes 1301 by laser cutting, so that the plurality of terminals 131 are not connected to each other. Furthermore, the terminal 131 and the material strip fixing portion 141 can be separated from each other. The terminal 131 and the material strip fixing portion 141 may be separated from each other by laser cutting, but are not limited thereto. In this way, the terminal base 130 combined with the rows of terminals 131 can be obtained, and the manufacturing of the terminal module 13 is completed.

It is worth mentioning that a cutting order between the first connection portion 1321, the second connection portion 1322, the material strip fixing portion 141 and the terminal 131 is not limited. For example, the first connecting portion 1321 and the second connection portion 1322 can be cut sequentially, and then the connection between the t material strip fixing portion 141 and the terminal 131 can be cut, but the above cutting order can also be changed.

To further explanation, as shown in FIG. 2D and FIG. 3B, for the terminal 131 manufactured by the second terminal manufacturing method, since the terminals 131 are independently stamped and formed, which are not connected to each other. After the plating layer is formed on the terminal 131, the terminal 131 can be separated from the strip fixing portion 141 by various methods such as automatic machinery or manual operation, and the terminals 131 can be placed in the plastic molding machine 80 according to the required number, such as any number from 1 to 100 to facilitate the subsequent embedded injection process, therefore the terminal base 130 can be formed on a plurality of terminals 131 spaced apart from each other. In this way, the terminal base 130 combined with the rows of terminals 131 can be obtained to complete the manufacturing of the terminal module 13.

It is worth mentioning that if the terminals 131 are manufactured by the above-mentioned first terminal manufacturing method, subsequent laser cutting is required, but if the terminals 131 are manufactured by the above-mentioned second terminal manufacturing method, there is no need to undergo laser cutting. Therefore, manufacturing the terminals 131 by the above-mentioned second terminal manufacturing method can be more cost-effective.

In summary, as shown in FIGS. 2C and 2D, the terminal module 13 of the present application includes a plurality of terminals 131 and the terminal base 130. The terminal base 130 covers the plurality of terminals 131. Each of the plurality of terminals 131 includes a root portion 132, a first terminal arm 133 and a second terminal arm 135. The root portion 132 is covered by the terminal base 130, and a terminal 134 of the first terminal arm 133 and a terminal 134 of the second terminal arm 135 are extended out of the terminal base 130.

In addition, in the terminal module 13 produced by the first terminal manufacturing method, a plurality of holes 1301 are also formed on each terminal base 130, and due to the above-mentioned laser cutting process, the plurality of terminals 131 correspond to the plurality of holes 1301 spaced apart from each other. For the terminal module 13 manufactured by the second terminal manufacturing method, since the terminal 131 is originally formed by independent stamping, there is no need to use a laser cutting process to manufacture the plurality of terminals 131, so there will be no holes 1301 in the terminal base 130.

It should be noted that since the interposer module 10 of the present application is equipped with thousands of terminals 131, and each terminal 131 is of millimeter-level micro size, it greatly increases the difficulty of assembling the terminals and the terminal base. Through the above stamping process, the terminals 131 are directly integrally formed on the continuous metal material strip, and then the terminal 131 and the terminal base 130 are combined using the embedded injection molding technology, which can accurately and firmly fix the terminal 131 to the terminal base 130, effectively reducing the difficulty of assembly, and further facilitating the subsequent combination of the terminal module 13 and the terminal slot 111.

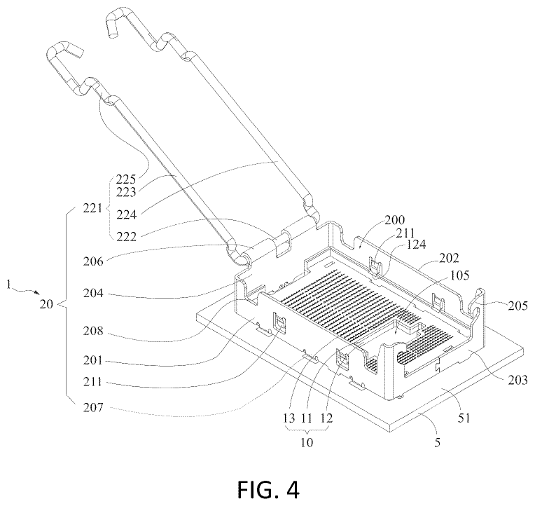

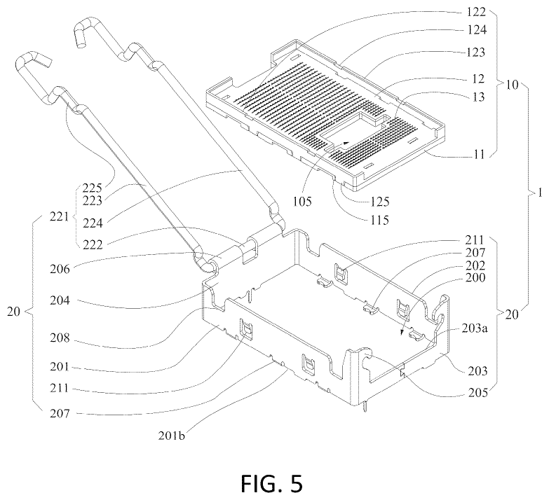

Referring to FIGS. 4 and 5, FIG. 4 is a schematic three-dimensional combination diagram of an electrical connector structure and a motherboard according to one embodiment of the present application. FIG. 5 is an exploded schematic diagram of the electrical connector structure of FIG. 4. As shown in FIG. 1, the present application provides an electrical connector structure 1, which includes an interposer module 10 and a fixed structure 20. In detail, the interposer module 10 includes a first board body 11 and a second board body 12 that can be assembled and detached from each other, and a plurality of terminal modules 13. Specifically, the second board body 12 and the first board body 11 are assembled in a stacked manner. A plurality of terminal modules 13 are disposed between the first board body 11 and the second board body 12. The plurality of terminal modules 13 are arranged side by side with each other, and each terminal module 13 includes a terminal base 130 and a plurality of terminals 131. In some embodiments, each terminal 131 includes a root portion 132, a first terminal arm 133, and a second terminal arm 135, and the root portion 132 is fixed to the terminal base 130, and the terminal 134 of the first terminal arm 133 extends out of the first board body 11, and wherein a terminal 136 of the second terminal arm 135 extends out of the second board body 12.

It is worth mentioning that since the terminal module 13 of the present application has a very small size and is arranged side by side, compared with the conventional practice (installing metal terminals into the entire plastic body), the method of arranging the terminal modules 13 side by side in the present application can break through the size limitation. The reason is that in the conventional manufacturing process, if injection molding is required at one time, a minimum volume of the plastic body will be limited in manufacturing. Therefore, the terminal module 13 of the present application can realize a possibility of maximizing the terminal density.

Continuing to refer to FIG. 4, the fixed structure 20 includes a pair of fixed walls 201 and 202, a front limiting wall 203 and a rear limiting wall 204, a plurality of first limiters 211 and a second limiter 221. In detail, the front limiting wall 203 and the rear limiting wall 204 are respectively connected between the front terminal and rear terminal of the pair of fixed walls 201 and 202, and together with the pair of fixed walls 201 and 202 form a frame structure, and can be fixed on a surface 51 of a motherboard 5 through, for example, surface adhesion technology, thereby forming an accommodation space 200. In this embodiment, the motherboard 5 is a circuit board on which one or a plurality of processors and electronic components (not shown) can be disposed, and is suitable for motherboards such as switches or servers. In some embodiments, the fixed walls 201 and 202, the front limiting wall 203 and the rear limiting wall 204 can be made of materials with high hardness properties, such as metal materials, preferably stainless steel, and can be formed through a metal stamping process. However, the above materials and preparation methods are not limited to this. As shown in FIGS. 4 and 5, a plurality of first limiters 211 are integrally formed by performing a stamping process on the fixed walls 201 and 202. The plurality of first limiters 211 protrude toward the accommodating space 200 and form a slope side 211a and a free terminal 211b, enable the first limiter 211 to be displaced outward due to a pressure of foreign objects in the accommodation space 200. In this embodiment, as shown in FIG. 2, the fixed walls 201 and 202 include a plurality of fixed pieces 207 and limiting grooves 208. Specifically, the limiting groove 208 is formed on a top edge 201a of the pair of fixed walls 201 and 202, and the fixing piece 207 are provided on a bottom 201b of the pair of fixed walls 201 and 202, and are bent toward the accommodation space 200 respectively. In this embodiment, the fixing piece 207 can be fixed on the surface 51 of the motherboard 5 through surface adhesive technology.

As shown in FIGS. 4 and 5, the interposer module 10 is detachably provided on the motherboard 5. In detail, the interposer module 10 enters the accommodation space 200 from directly above the accommodation space 200 downward, and interferes with the slope side 211a of the first limiters 211 on the opposite sides during the downward movement. 211a, then the first limiters 211 is pushed outward, and after passing the first limiter 211, the first limiter 211 returns to its original position and its free terminal 211a is pressed and fixed on the surface 51 of the motherboard 5. Through the above crimping method, the interposer module 10 can be firmly fixed on the motherboard 5, and the first terminal arm 133 contacts the corresponding conductive contact (not shown) of the motherboard 5. When the interposer module 10 is to be detached from the fixed structure 20, the first limiter 211 can be pushed outward from the accommodating space 200 to take out the interposer module 10.

It should be noted that in other embodiments, the fixed structure 20 can also only have the pair of fixed walls 201 and 202 without the front limiting wall 203 and the rear limiting wall 204, wherein the fixed walls 201 and 202 can utilize the diagonal bracing structure (not shown) supported on the main plate 5 to enhance the structural strength. In other embodiments, the fixed walls 201 and 202 may also adopt a plurality of columnar structures (not shown). Through the arrangement of the above-mentioned fixed walls 201 and 202, the first limiter 211 can also be used to press and fix the interposer module 10.

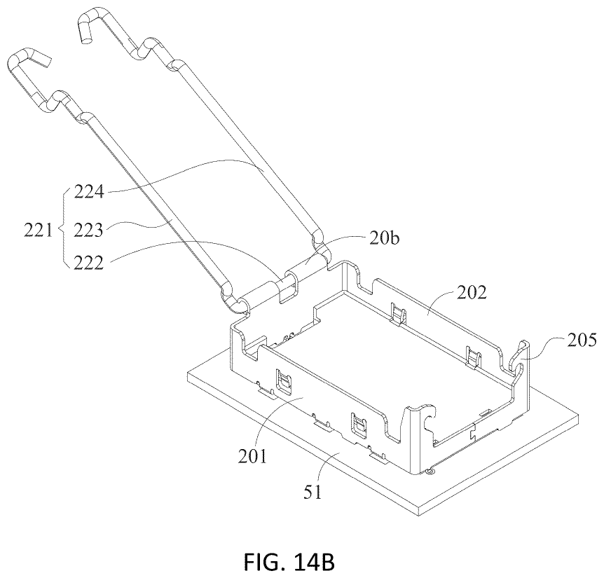

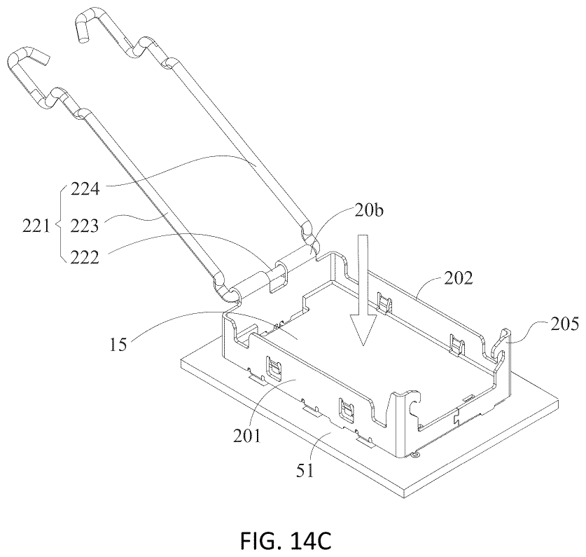

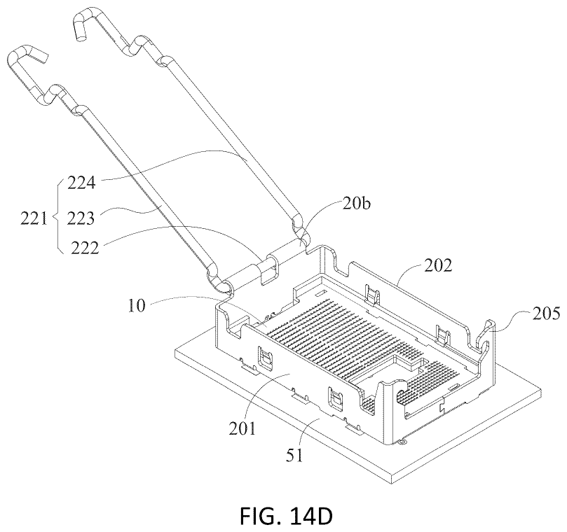

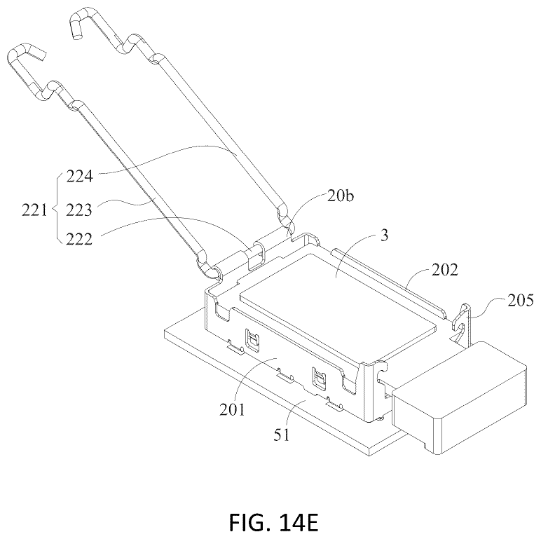

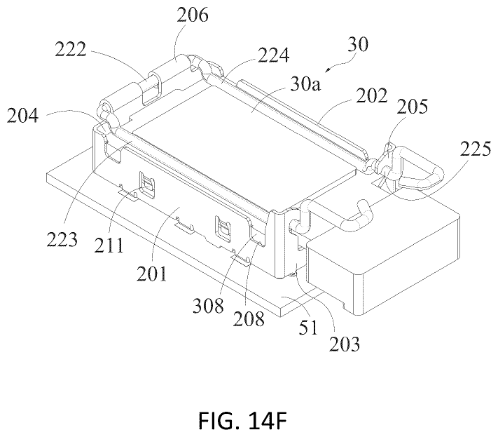

As shown in FIG. 5, the rear limiting wall 204 includes a pivot portion 206 with an axis hole, and the second limiter 221 is pivotably connected to the pivot portion 206 and is disposed above the first limiter 211. In detail, the front limiting wall 203 includes an opening 203a and a pair of holding portions 205, and the holding portions 205 are disposed on a top of the front limiting wall 203 and positioned on both sides of the opening 203a. In some embodiments, each of the pair of holding portions 205 has an underhook structure. As shown in FIG. 2, the second limiter 221 includes a pair of pressure rods 223 and 224 and a connecting rod 222 connected between the pair of pressure rods, wherein the pressure rods 223 and 224 and the connecting rod 222 are integrally formed to form a U-shaped structure, and a material of the second limiter 221 can be the same as the fixed walls 201 and 202. In detail, the connecting rod 222 is pivotably connected to the pivot portion 206, and rotates with the pivot portion 206 as the axis to link the pressure rods 223 and 224 to rotate between an open state (as shown in FIG. 4) and a holding state (as shown in FIG. 14A), to press the optoelectronic transceiver module 3 or release the pressure on the optoelectronic transceiver module 3 (details will be described later). In some embodiments, the pressure rods 223 and 224 extend close to the fixed walls 201 and 202. Each pressure rod 223 and 224 includes an operating portion 225 that extends a preset distance outside the holding portion 205 and is bent upward to facilitate the rotation of the operating pressure rods 223 and 224 between the open state and the holding state. One terminal of the pressure rods 223 and 224 away from the connecting rod 222 is movably held in the holding portion 205 of the underhook structure when the pressure rods 223 and 224 are in the holding state.

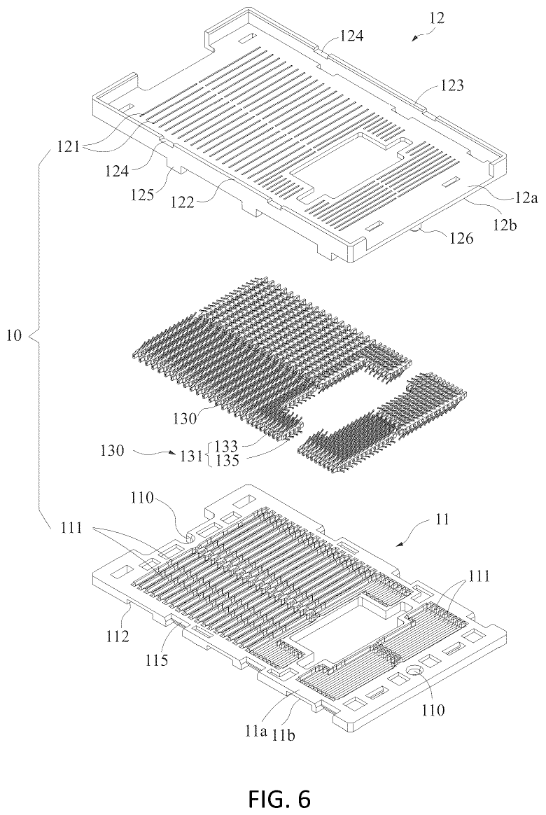

Referring to FIG. 6, FIG. 6 is a three-dimensional exploded schematic diagram of the interposer module 10 according to one embodiment of the present application. As shown in FIG. 5, the first board body 11 includes a plurality of terminal slots 111 and a plurality of first positioning grooves 112, wherein the plurality of terminal slots 111 penetrates an upper surface 11a and a lower surface 11b of the first board body 11 in a thickness direction. In detail, each terminal slot 111 extends toward a short axis direction of the first board body 11, and the plurality of terminal slots 111 are arranged at intervals along a long axis direction of the first board body 11. The second board body 12 is detachably assembled to the first board body 11 and includes a pair of side walls 122 and 123 and a plurality of through grooves 121, and the plurality of through grooves 121 are provided corresponding to the terminal slots 111 and communicate with the terminal slots 111.

As shown in FIG. 6, the pair of side walls 122 and 123 are spaced apart from each other on a top 12a of the second board body 12, and are close to and parallel to the fixed walls 201 and 202, wherein each side wall 122 and 123 includes a plurality of second positioning grooves 124. A plurality of second positioning grooves 124 are respectively provided on a top of the side walls 122 and 123. In this embodiment, the first limiter 211 presses the corresponding second positioning groove 124 (as shown in FIG. 4) to fix the interposer module 10 on the motherboard 5. In addition, the fixing pieces 207 of the fixing walls 201 and 202 are inserted into the corresponding first positioning grooves 112 to further limit the first board body 11 in the long axis direction. As shown in FIGS. 5 and 6, the terminal base 130 of the terminal module 13 is disposed in the terminal slot 111 and between the first board body 11 and the second board body 12. The terminal 134 of the first terminal arm 133 extends out of the terminal slot 111, and the terminal 136 of the second terminal arm 135 extends out of the through slot 121.

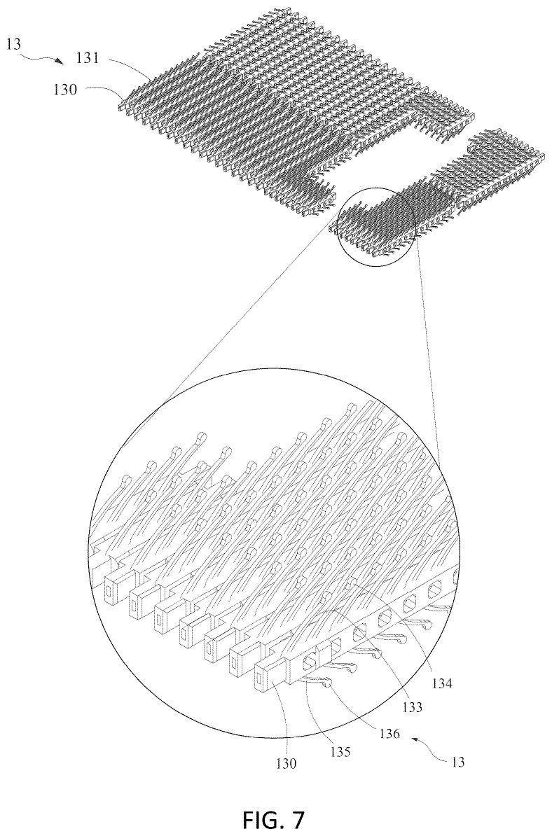

Continuing to refer to FIGS. 6 to 7, in some embodiments, the first board body 11 includes a plurality of first engaging assemblies 115, the second board body 12 includes a plurality of first engaging components 125, wherein the first engaging component 125 is detachably engaged with the first engaging assembly 115. Preferably, the first engaging component 125 is a hook protruding downward, and the first engaging assembly 115 is a groove for the hook to engage. A bottom 12b of the second board body 12 is attached to an upper surface 11a of the first board body 11, and a bottom 12b of the second board body 12 includes a plurality of positioning posts 126, wherein the positioning posts 126 extend toward the direction of the first board body 11. The first board body 11 also includes a plurality of through holes 110. The motherboard 5 includes a plurality of positioning holes 510, wherein a plurality of positioning posts 126 respectively penetrate the plurality of through holes 110 and are inserted into the plurality of positioning holes 510 to further position the interposer module 10 on the motherboard 5.

Continuing to refer to FIGS. 6 to 7 and in conjunction with FIGS. 2A to 2C, the first terminal arm 133 is inclined from the root 132 toward a middle of the terminal slot 111 of the first board body 11 and the accommodation space 200, wherein the second terminal arm 135 is inclined from the root 132 toward a middle of the through groove 121 of the second board body 12 and the accommodation space 200, and the first terminal arm 133 and the second terminal arm 135 are arranged symmetrically up and down relative to the root 132. In this embodiment, the second terminal arm 135 has an outwardly convex arc-shaped section relative to the terminal base 130, which extends from the root 132 to the end 136 of the second terminal arm 135, and the first terminal arm 133 has an arc-shaped cross section that is the same as an arc-shaped cross section of the second terminal arm 135. The terminal base 130 covers the root portion 132, and the plurality of terminals 131 are aligned in rows and spaced apart from each other on the terminal base 130. In some embodiments, the terminals 134 and 136 have convex arc-shaped profiles to facilitate contact with the mating conductive contacts. Specifically, the second terminal arm 135 and the first terminal arm 133 can be deformed by being pressed by a foreign object, and can return to their original shape when the pressure is released.

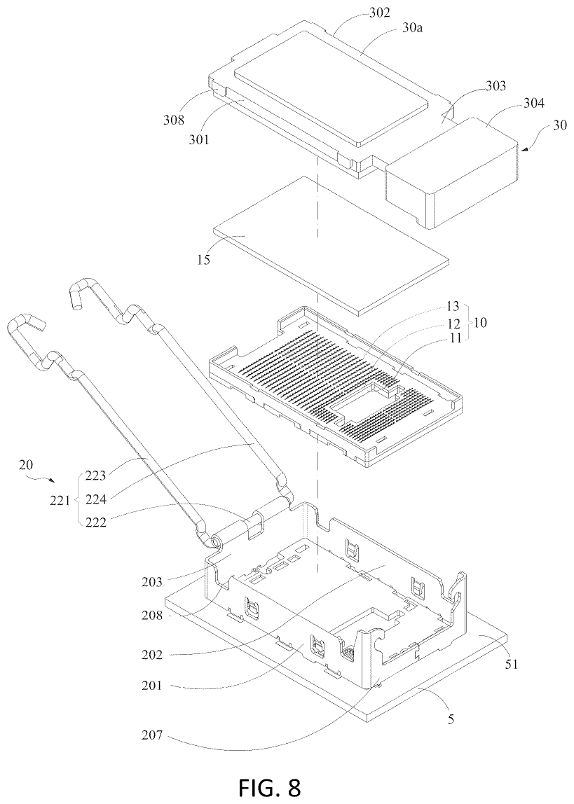

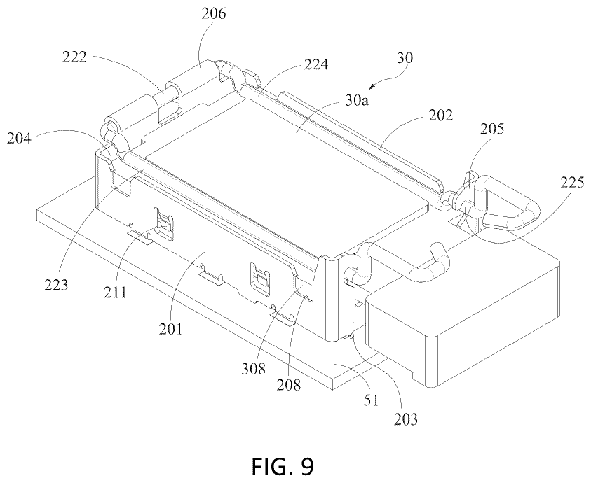

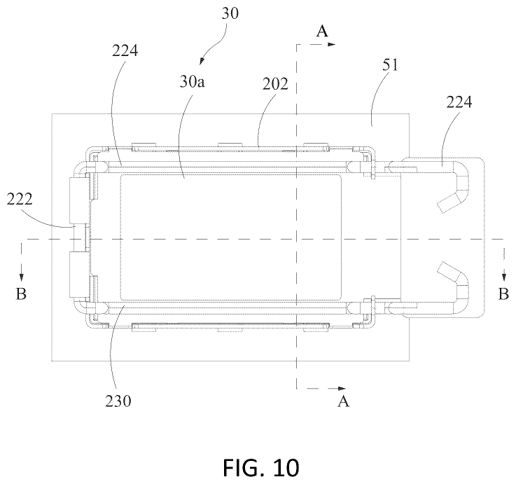

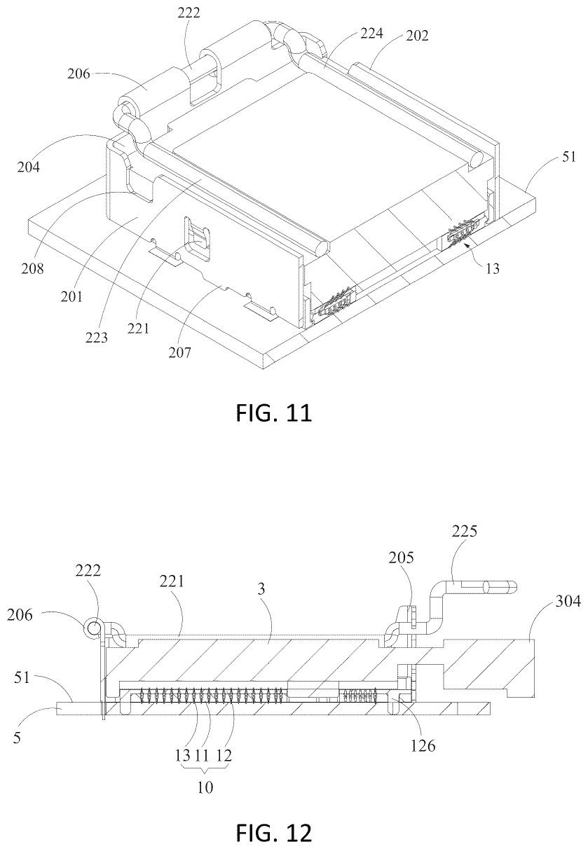

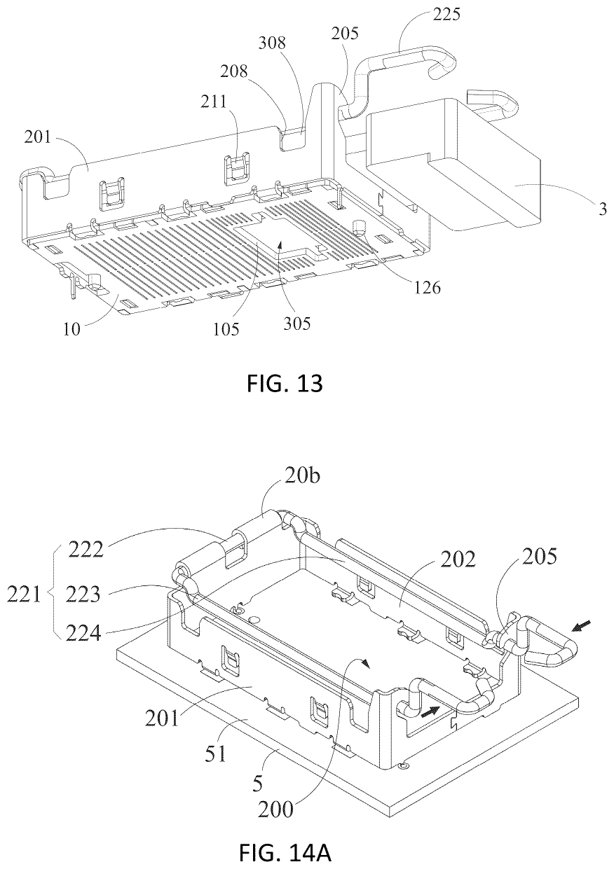

Referring to FIGS. 8 to 13, FIG. 8 is a three-dimensional exploded schematic diagram of the electrical connector structure 1 and an optoelectronic transceiver module 3 according to one embodiment of the present application. FIG. 9 is a schematic three-dimensional combination diagram of the electrical connector structure 1 and the optoelectronic transceiver module 3 of FIG. 8. FIG. 10 is a top view of the electrical connector structure 1, the optoelectronic transceiver module 3, and the motherboard 5 of FIG. 9, FIG. 11 is a cross-sectional view of line A-A in FIG. 10, FIG. 12 is a cross-sectional view of line B-B in FIG. 10, FIG. 13 is a schematic three-dimensional combination diagram of the electrical connector structure and the optoelectronic transceiver module of FIG. 9 from a downward perspective. As shown in FIG. 8, the electrical connector structure 1 of the embodiment of the present application also includes a protective cover 15, which removably covers the top 12a of the second board body 12 to protect the exposed terminals 131 during assembly. In some embodiments, as shown in FIG. 8, the optoelectronic transceiver module 3 includes a top 30a, two opposite sides 301 and 302, a neck 303, a joint portion 304 and a plurality of limiting protrusions 308. In some embodiments, the joint portion 304 is used to connect multiple optical fibers (not shown) or cables (not shown) to transmit and receive optical signals or electrical signals. In detail, the limiting protrusions 308 are provided on two opposite sides 301 and 302 of the optoelectronic transceiver module 3. After the interposer module 10 enters the accommodation space 200 and is fixed on the motherboard 5 through the crimping method, the protective cover 15 is removed, and the photoelectric transceiver module 3 is detachably disposed on the interposer module 10 through the crimping method, wherein the limiting protrusion 308 is detachably engaged with the limiting grooves 208 of the fixed walls 201 and 202 (as shown in FIG. 9).

As shown in FIGS. 11 and 12, after the optoelectronic transceiver module 3 is positioned by crimping, the pressure rods 223 and 224 of the second limiter 221 press the top 30a of the optoelectronic transceiver module 3, and the bottom of the optoelectronic transceiver module 3 is positioned in the fixed walls 201 and 202, and the optoelectronic transceiver module 3 is electrically connected to the motherboard 5 through a plurality of terminals 131 of the interposer module 10. As shown in FIG. 13, the bottom of the optoelectronic transceiver module 3 includes a positioning protrusion 305. The interposer module 10 includes a hollow portion 105 (as shown in FIG. 2). The positioning protrusion 305 is inserted into the hollow portion 105 to further position the photoelectric transceiver module 3 and the interposer module 10 on the main board 5.

Referring to FIGS. 14A to 14F, FIGS. 14A to 14F are schematic flow diagrams of the optoelectronic transceiver module being connected to the electrical connector structure of the embodiment of the present application in a crimping manner. When connecting, first assemble the fixed structure 20 on the motherboard 5 at a predetermined position (as shown in FIG. 14A), then lift the second limiter 221 to the open state (as shown in FIG. 14B), and then use the protective cover 15 presses the interposer module 10 downward from the top of the motherboard 5 into the accommodation space 200, so that the interposer module 10 presses against the surface 51 of the motherboard 5 through the first limiter 211 (as shown in FIG. 14C), after the interposer module 10 is positioned, the protective cover 15 is removed (as shown in FIG. 14D), and the optoelectronic transceiver module 3 is placed into the accommodation space 200 from top to bottom, and the limiting protrusion is 308 is fitted into the limiting groove 208 (as shown in FIG. 14E). Finally, the second limiter 221 is placed back into the retaining state (as shown in FIG. 14F), and the terminals of the pressing levers 223 and 224, which are away from the connecting rod 222, are retained in the retaining portion 20 with a barb structure. At this time, the pressing levers 223 and 224 press the top 30a of the optoelectronic transceiver module 3, thereby completing the connection between the optoelectronic transceiver module 3 and the interposer module 10, so that the optoelectronic transceiver module 3 can be electrically connected to the motherboard 5 through a plurality of terminals 131 of the interposer module 10. Similarly, when taking out the optoelectronic transceiver module 3, reverse the above steps to open the second limiter 221 to the open state, and then the optoelectronic transceiver module 3 can be taken out.

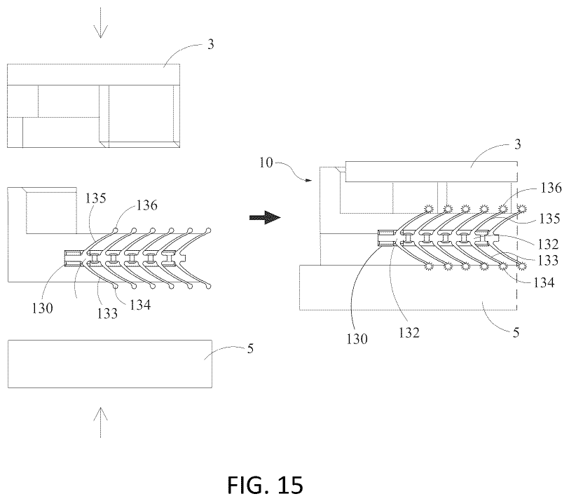

Referring to FIG. 15, FIG. 15 is a schematic structural diagram of the contact between the terminal 131 and the optoelectronic transceiver module 3. As shown in FIG. 15, when the optoelectronic transceiver module 3 is pressed against the second board body 12 from top to bottom, the conductive contact (not shown) at a bottom of the optoelectronic transceiver module 3 contacts the terminal 136 of the second terminal arm 135 and forces the second terminal arm 135 to move downward, so that each terminal 131 can be reliably connected to the corresponding conductive contact.

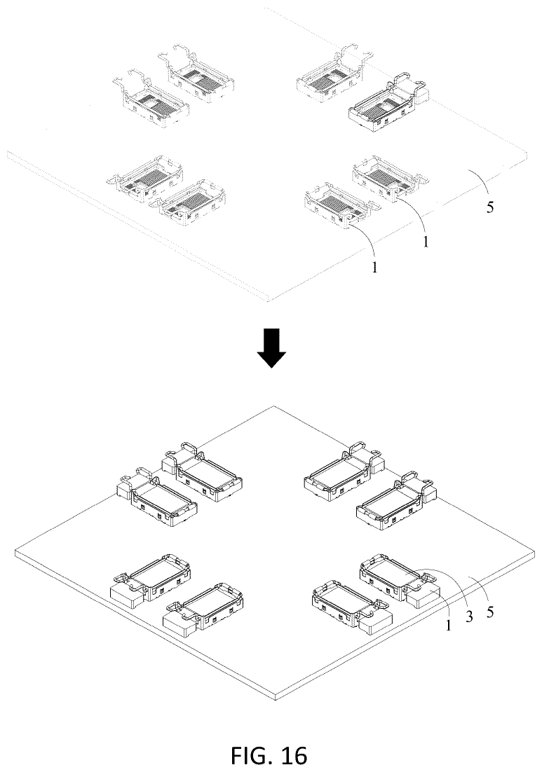

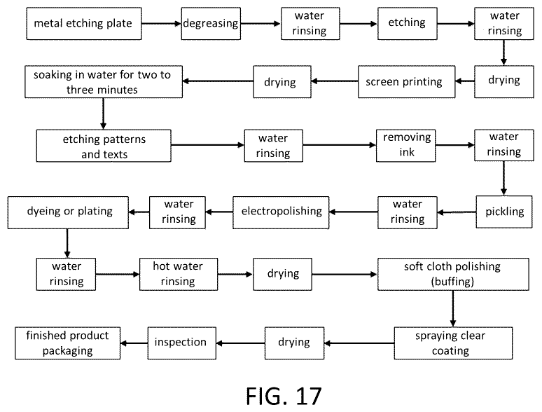

Referring to FIG. 16, which is a schematic diagram of a usage state of the electrical connector structure 1 according to the embodiment of the present application. As shown in FIG. 16, the middle part of the motherboard 5 can be provided with electronic components (not shown) such as a processor, and a plurality of sets of electrical connector structures 1 and optoelectronic transceiver modules 3 can be respectively configured around the motherboard 5. In practice, the number of groups of electrical connector structures 1 and optoelectronic transceiver modules 3 depends on the needs and is not particularly limited. Each optoelectronic transceiver module 3 is connected to an external signal transmission component, such as an optical fiber or a cable (not shown). The above structure can be used to handle high-capacity signal transmission and reception to meet the needs of high-speed and large-scale signal processing.

To sum up, in one embodiment of the terminal manufacturing method of the present application, the number of required terminals can be adjusted by laser cutting to manufacture the terminal module. In another embodiment of the terminal manufacturing method of the present application, the terminals can be formed independently, and subsequently the terminal module can be manufactured according to the required number of terminals without the need for laser cutting. In addition, because the terminals of the present application are manufactured by stamping, compared with the conventional etching manufacturing method, they have the advantages of dimensional stability, high precision, fast production, and convenient terminal storage and protection.

In the electrical connector structure of the embodiment of the present application, the interposer module and the optoelectronic transceiver module can be stacked in sequence by a crimping method and detachably provided in the fixed structure, and use the first limiter and the second limiter firmly press the interposer module and the optoelectronic transceiver module respectively, so that the optoelectronic transceiver module can be connected to the electrical connector structure through a simple crimping method. Furthermore, the integrated terminals of the interposer module are directly electrically connected to the motherboard, so that the photoelectrically converted electrical signals from the optoelectronic transceiver module can be transmitted to the motherboard, so as to fully utilize the high performance provided by the optoelectronic transceiver module, which has the advantages of high capacity and high-speed transmission, shortens the transmission distance between the optoelectronic transceiver module and the motherboard, and facilitates maintenance and replacement, thereby effectively solves the problem that currently co-packaged optical components must be connected to the motherboard through cables and connectors, resulting in long transmission paths and difficulty in repair and replacement.

The above is only illustrative and not restrictive. Any equivalent modifications or changes that do not depart from the spirit and scope of the present invention shall be included in the appended claim scope.

What is claimed is:

1. A terminal manufacturing method, comprising:
providing a material strip;
placing the material strip in a stamping machine;
performing a stamping process on the material strip by the stamping machine, and forming at least one terminal and at least one material strip fixing portion on the material strip, wherein the at least one terminal is connected to the at least one material strip fixing portion; and
separating the at least one terminal from the at least one material strip fixing portion.

2. The terminal manufacturing method according to claim 1, further comprising forming a plurality of terminal protection feet by performing the stamping process through the stamping machine.

3. The terminal manufacturing method according to claim 2, further comprising cutting the plurality of terminal protection feet by laser.

4. The terminal manufacturing method according to claim 1, further comprising forming a plurality of first positioning holes on one side of the material strip, wherein a feeding mechanism sequentially pushes the material strip in one direction through the plurality of first positioning holes.

5. The terminal manufacturing method according to claim 4, further comprising forming a plurality of second positioning holes on the other side of the material strip, wherein the feeding mechanism sequentially pushes the material strip in one direction through the plurality of first positioning holes and the plurality of second positioning holes.

6. The terminal manufacturing method according to claim 1, wherein after forming the at least one terminal, the terminal manufacturing method further comprising electroplating the at least one terminal.

7. The terminal manufacturing method according to claim 6, wherein the terminal manufacturing method further comprises plating nickel on the at least one terminal by electroplating, and then plating silver, gold, or palladium on the at least one terminal by electroplating.

8. The terminal manufacturing method according to claim 1, wherein the material strip is defined with a plurality of stamping areas, and wherein the terminal manufacturing method further comprises forming a plurality of terminals in each of the stamping areas by using a mold of the stamping machine.

9. The terminal manufacturing method according to claim 8, wherein the terminal manufacturing method further comprises laser cutting the connection portions between the plurality of terminals in each of the stamping areas according to a predetermined number.

10. The terminal manufacturing method according to claim 8, wherein the material strip is defined with the plurality of stamping areas, and wherein the terminal manufacturing method further comprises forming each terminal in each stamping area.

11. An electrical connector structure for connecting an optoelectronic transceiver module on a motherboard, wherein the electrical connector structure comprises:
an interposer module comprising a plurality of terminal modules, wherein each of the plurality of terminal modules comprises a plurality of terminals, and wherein each of the plurality of terminal modules are arranged side by side; and
a fixed structure comprising a pair of fixed walls, a plurality of first limiters, and a second limiter, wherein the pair of fixed walls are arranged on the motherboard and are spaced apart from each other to form an accommodation space, wherein the plurality of first limiters are respectively disposed on the pair of fixed walls and protrude toward the accommodation space, wherein the second limiter is disposed above the plurality of first limiters, wherein the interposer module and the optoelectronic transceiver module can be stacked in sequence and detachably arranged in the accommodation space, and wherein the plurality of first limiters limit the interposer module on the motherboard, and wherein the second limiters limit the optoelectronic transceiver module on the interposer module, and wherein the optoelectronic transceiver module is electrically connected to the motherboard through a plurality of terminals of the interposer module.

12. The electrical connector structure according to claim 11, wherein the interposer module further comprises a first board body and a second board body assembled with each other, and wherein the terminal module is disposed between the board body and the second board body and the terminal module comprising a terminal base and a plurality of terminals, and wherein each terminal comprises a root portion, a first terminal arm and a second terminal arm, and wherein the root portion is fixed to the terminal base, and wherein one terminal of the first terminal arm extends out of the first board body, and wherein one terminal of the second terminal arm extends out of the second board body.
